(19) United States
(12) Patent Application Publication
(10) Pub. No.: US 2026/0080196 A1
(43) Pub. Date: Mar. 19, 2026

(54) INKJET PRINT APPARATUS

(71) Applicant: KEYENCE CORPORATION, Osaka-shi (JP)

(72) Inventors: Hayato Funahashi, Osaka-shi (JP); Naoki Tokunaga, Osaka-shi (JP)

(73) Assignee: KEYENCE CORPORATION, Osaka-shi (JP)

(21) Appl. No.: 19/325,859

(22) Filed: Sep. 11, 2025

(30) Foreign Application Priority Data
Sep. 19, 2024 (JP) 2024-161946

(51) Int. Cl. G06K 15/00; G06K 15/10; G06T 7/00

(52) U.S. Cl. CPC G06K 15/005; G06K 15/102; G06T 7/0004; G06T 2207/30144

(57) ABSTRACT

The timing adjustment of an imaging trigger is facilitated. An inkjet print apparatus includes: an imaging section that captures a drawing pattern formed on an object to be drawn with ink and generates a captured image; an inspection machine that performs image inspection of the drawing pattern using the captured image; a storage section that stores area information indicating an area in which the drawing pattern on the object to be drawn can be captured, the area information being determined on the basis of an angle of view information defining an imaging field of view of the imaging section; a detection sensor that detects arrival of the object to be drawn; and a control section that determines an issuance timing of an imaging trigger on the basis of the area information, a position of an element, and a detection timing of the detection sensor.

### CROSS-REFERENCE TO RELATED APPLICATIONS

The present application claims foreign priority based on Japanese Patent Application No. 2024-161946, filed Sep. 19, 2024, the contents of which are incorporated herein by reference.

### BACKGROUND OF THE INVENTION

### 1. Technical Field

The present disclosure relates to an inkjet print apparatus.

### 2. Description of the Related Art

For example, a drop on demand (DOD) type inkjet print apparatus that performs printing by ejecting ink onto a packaging material such as cardboard is known (See, for example, JP2014-144574A).

Furthermore, there is also known a technique in which a pattern drawn by a DOD type inkjet print apparatus is captured by a camera, and alignment or the like is performed using the obtained captured image (For example, see JP2020-131141A).

By the way, it is conceivable to capture a pattern drawn by the inkjet print apparatus with a camera and execute pattern inspection or the like using the obtained captured image. In this case, it is necessary to issue an imaging trigger at the optimum timing when the drawn pattern enters the field of view of the camera, but in order to set an issuance timing of the imaging trigger to the optimum timing, it is necessary to actually test draw the pattern on an object to be drawn and adjust the timing of the imaging trigger while viewing the object to be drawn subjected to the test drawing. Such timing adjustment work is complicated and troublesome, and it is not easy to adjust the timing of the imaging trigger unless the skilled person is familiar with both the inkjet print apparatus and the camera.

### SUMMARY OF THE INVENTION

The present disclosure has been made in view of the above point, and an object thereof is to facilitate timing adjustment of an imaging trigger.

In order to achieve the above object, an inkjet print apparatus according to one embodiment of the present disclosure includes: an ink accommodation section configured to accommodate ink; an ejection section configured to eject ink supplied from the ink accommodation section toward an object to be drawn conveyed by a conveyance device; an imaging section configured to capture an image of a drawing pattern formed on the object to be drawn with the ink ejected from the ejection section and generate a captured image; an image inspection section configured to perform image inspection of the drawing pattern using the captured image generated by the imaging section; a storage section configured to store area information indicating an area in which an image of the drawing pattern on the object to be drawn can be captured, the area information being determined on the basis of an angle of view information defining an imaging field of view of the imaging section; a display section configured to display a setting surface corresponding to the drawing area on the object to be drawn that is to be drawn with the ink ejected from the ejection section; a setting section configured to, on the basis of a user operation, dispose an element according to the drawing pattern on the setting surface displayed on the display section and set a drawing content; a detection sensor configured to detect arrival of the object to be drawn conveyed by the conveyance device; and a control section configured to determine an issuance timing of an imaging trigger on the basis of the area information stored in the storage section, a position of the element disposed on the setting surface by the setting section, and a detection timing of the detection sensor.

According to this configuration, the imaging trigger at the optimum timing for performing the image inspection of the drawing pattern is automatically generated on the basis of the area information stored in the storage section, the position of the element disposed on the setting surface by the setting section, and the detection timing of the detection sensor that detects the object to be drawn. Therefore, the imaging section can generate the captured image in which the image inspection of the drawing pattern can be performed even if the user does not perform complicated adjustment work of performing the timing adjustment of the imaging trigger while viewing the object to be drawn subjected to test drawing.

As described above, in a case where the image inspection is performed on the drawing pattern formed on the object to be drawn, the timing adjustment of the imaging trigger for imaging the drawing pattern can be easily performed.

### BRIEF DESCRIPTION OF THE DRAWINGS

FIG. 1 is a diagram illustrating an overall configuration of an inkjet print apparatus according to an embodiment of the present invention;

FIG. 2 is a block diagram of an inkjet print apparatus;

FIG. 3 is a plan view illustrating an installation example of a drawing machine and an inspection machine;

FIG. 4 is a front view illustrating an installation example of the drawing machine and the inspection machine;

FIG. 5 is a flowchart illustrating an example of a procedure of drawing setting and inspection setting;

FIG. 6 is a diagram illustrating an example of a setting screen;

FIG. 7 is a diagram illustrating an example of a job list display screen;

FIG. 8 is a diagram illustrating an example of a drawing element list display screen;

FIG. 9 is a diagram illustrating an example of a block addition screen;

FIG. 10 is a diagram illustrating an example of a block editing screen;

FIG. 11 is a diagram illustrating an example of an adjustment screen;

FIG. 12 is a conceptual diagram for specifying an end portion of a drawing pattern;

FIG. 13 is a diagram illustrating an example of a display form on an upstream side and a downstream side of a closest point;

FIG. 14 is a diagram illustrating a calculation method of an imaging delay time;

FIG. 15 is a diagram illustrating an example of a captured image;

FIG. 16 is an example of an input screen in a case where an imaging trigger is caused to be linked with a drawing trigger;

FIG. 17 is an example of an input screen in a case where the imaging trigger is caused not to be linked with the drawing trigger;

FIG. 18 is an example of an input screen in a case where a workpiece moves at a constant speed;

FIG. 19 is an example of an input screen in a case where an encoder is used;

FIG. 20 is an example of an inspection setting screen;

FIG. 21 is a flowchart at the time of operation of the inkjet print apparatus; and

FIG. 22 is a timing chart of a detection sensor, the drawing machine, and the inspection machine.

### DETAILED DESCRIPTION

Hereinafter, embodiments of the present invention will be described in detail with reference to the drawings. Note that the following description of preferred embodiments is merely exemplary in nature and is not intended to limit the present invention, its application, or its use.

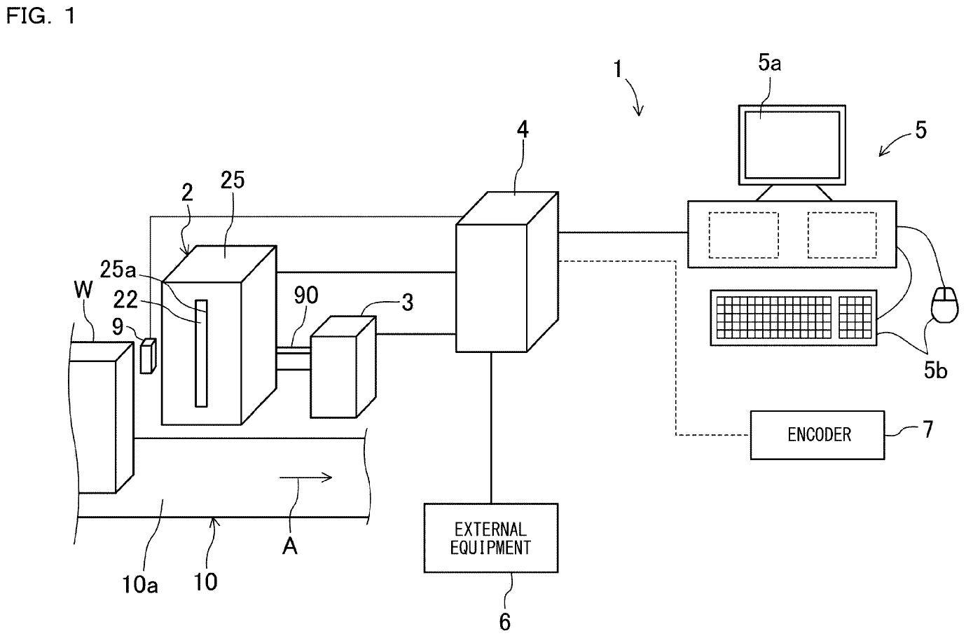

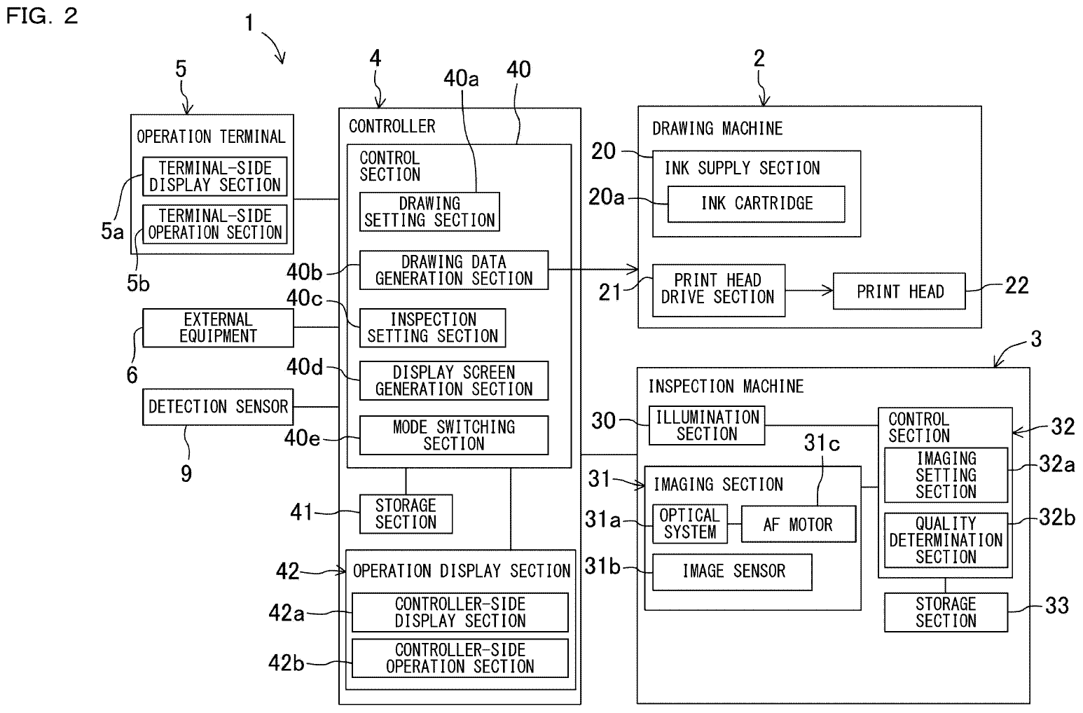

FIG. 1 is a diagram illustrating an overall configuration at the time of operation of an inkjet print apparatus 1 according to an embodiment of the present invention, and FIG. 2 is a block diagram of the inkjet print apparatus 1. The inkjet print apparatus 1 includes, for example, a drawing machine 2, an inspection machine 3, a controller 4, and an operation terminal 5.

The drawing machine 2 is a part that performs drawing processing on an object to be drawn, and is configured separately from the controller 4. The inspection machine 3 is a part that determines the quality of the drawing state executed on the object to be drawn by the drawing machine 2, and is configured separately from the controller 4. Since the inkjet print apparatus 1 according to the present embodiment includes the drawing machine 2 and the inspection machine 3, the inkjet print apparatus 1 is an inkjet print apparatus that ejects ink for drawing information onto an object and determines the quality of a drawing state by imaging.

The controller 4 is a part that controls the drawing machine 2 and the inspection machine 3, and can also be referred to as a control device, a control unit, or the like. Furthermore, the operation terminal 5 includes a personal computer or the like, and is a part where a user inputs drawing information, performs various settings, selects, confirms, and the like, for example. The operation terminal 5 includes a terminal-side display section 5a including, for example, a liquid crystal display, and a terminal-side operation section 5b including a keyboard, a mouse, a pointing device, and the like.

The above configuration example is an example, and the present invention is not limited to the above configuration example. That is, the controller 4 may be incorporated into the operation terminal 5 or may be incorporated into the drawing machine 2. Furthermore, the operation terminal 5 may function as the controller 4. Furthermore, FIGS. 1 and 2 illustrate external equipment 6 including a programmable logic controller (PLC) or the like, and the external equipment 6 is communicably connected to the controller 4. A control signal output from the external equipment 6 is input to the controller 4. The external equipment 6 may be equipment constituting a part of the inkjet print apparatus 1, or may be equipment different from the inkjet print apparatus 1.

The inkjet print apparatus 1 is an apparatus for forming a drawing pattern on a workpiece W (an example of a drawing target) conveyed by a conveyor (an example of a conveyance device) 10, and is an in-line apparatus used by being incorporated into a manufacturing line (also referred to as a production line). The conveyor 10 is, for example, a belt conveyor, a roller conveyor, or the like. The production line is configured by the conveyor 10. The production line is installed in various factories, warehouses, and the like. The drawing machine 2 is fixed such that the relative position with respect to the conveyor 10 has a predetermined positional relationship.

During operation of the inkjet print apparatus 1, the plurality of workpieces W are sequentially conveyed in the direction of the arrow A illustrated in FIG. 1 in a state of being placed on a conveyance surface 10a of the conveyor 10. Therefore, the upstream side in the conveyance direction is the left side in FIG. 1, and the downstream side in the conveyance direction is the right side in FIG. 1. The plurality of workpieces W are placed on the conveyance surface 10a in a state of being spaced apart from each other in the direction of the arrow A which is the conveyance direction. A direction orthogonal to the direction of the arrow A and along the conveyance surface 10a is defined as a width direction.

The workpiece W is not particularly limited, and examples thereof include a packing material for packing various products. As a typical example of the packing material, for example, cardboard and the like can be mentioned. The inkjet print apparatus 1 draws information such as characters including numbers, symbols, bar codes, two-dimensional codes, images, marks, illustrations, combinations thereof, and the like on the workpiece W conveyed by the conveyor 10. In a case where only characters are drawn, the inkjet print apparatus 1 can also be referred to as a printing apparatus or the like, and the drawing machine 2 can also be referred to as a printing machine. Furthermore, the drawing of information by the inkjet print apparatus 1 also includes the case of printing an image or the like. In this case, the inkjet print apparatus 1 can be referred to as a print apparatus. In the following description, character printing and printing are simply referred to as drawing.

Furthermore, an encoder 7 for detecting a position of the workpiece W, a detection sensor 9 to be described later, and the like are connected to the controller 4. The controller 4 detects the position of the workpiece W on the basis of signals output from the encoder 7 and the detection sensor 9. The controller 4 controls the drawing machine 2 so that drawing is started when the workpiece W arrives at a predetermined position.

### (Configuration of Drawing Machine 2)

The drawing machine 2 is a drop on demand (DOD) type drawing machine that ejects ink only when necessary as a drawing operation, but may be a continuous ink jet (CIJ) type drawing machine that ejects ink even when the drawing operation is not performed, in addition to the DOD type drawing machine. Hereinafter, a case where a DOD type drawing machine is used as the drawing machine 2 of the present embodiment will be described.

As illustrated in FIG. 2, the drawing machine 2 includes an ink supply section 20, a print head drive section 21, and a DOD print head (Hereinafter, referred to as a print head.) 22. The drawing machine 2 also includes a main housing 25 (illustrated in FIG. 1) in which the print head 22 is provided. The main housing 25 is fixed to the conveyor 10 or the like.

The print head 22 is fixed in a state of being accommodated in the main housing 25, and a positional relationship between the main housing 25 and the print head 22 is fixed. Furthermore, the ink supply section 20 and the print head drive section 21 are also accommodated inside the main housing 25.

The print head 22 of the DOD type drawing machine 2 is a member corresponding to an ejection section, and ejects ink supplied from the ink cartridge 20a toward the workpiece W conveyed by the conveyor 10. A drawing pattern is formed on the workpiece W by the ink ejected from the print head 22. There are a plurality of types of structures of the print head 22, and for example, any of a thermal inkjet type, a valve jet type, and a piezo type may be used. In the present embodiment, a piezoelectric print head capable of performing low resolution to high resolution drawing, having a wide drawing width, and having high durability is used as the print head 22.

In the print head 22, a plurality of ejection ports (not illustrated) are formed, for example, along the up-down direction. As illustrated in FIG. 1, an opening 25a that is long in the up-down direction is formed on a surface of the main housing 25 facing the workpiece W. The surface of the print head 22 on which the ejection port is formed is disposed so as to face the outside from the opening 25a of the main housing 25. Therefore, the ink ejected from the ejection port of the print head 22 jumps out of the main housing 25 from the opening 25a of the main housing 25 and adheres to the workpiece W.

The ink supply section 20 is a part that supplies ink to the print head 22, and includes an ink cartridge 20a as an ink accommodation section that accommodates ink. Instead of the ink cartridge 20a, an ink reservoir (ink accommodation section) that can refill ink may be provided.

The print head drive section 21 is controlled by a control section 40 described later when performing the drawing operation. The print head drive section 21 generates a driving electric waveform for driving the print head 22 and outputs the driving electric waveform to the print head 22. The drive electric waveform is a waveform for individually driving the drive element (piezoelectric vibrator) provided for each ejection port of the print head 22 at a timing based on the drawing command output from the control section 40.

### (Configuration of Inspection Machine)

The inspection machine 3 is a device that determines whether the drawing state of the drawing pattern drawn on the workpiece W to be drawn is good or bad on the basis of the drawing data by using a captured image acquired by imaging the workpiece W to be drawn, and corresponds to an image inspection section. Furthermore, the inspection machine 3 can also be referred to as an image inspection device. The inspection machine 3 is installed downstream of the drawing machine 2, and can inspect the drawing state of the workpiece W drawn by the drawing machine 2.

The inspection machine 3 includes an illumination section 30, an imaging section 31, a control section 32, and a storage section 33. The illumination section 30 includes, for example, a light emitting diode or the like, and is controlled by the control section 32 to emit light at a predetermined timing to illuminate a drawn portion of the workpiece W. The imaging section 31 is a member for capturing an image of a drawing pattern formed on the workpiece W and generating a captured image. The imaging section 31 includes an optical system 31a including a lens that receives light emitted from the illumination section 30 and reflected from the surface of the workpiece W, an image sensor 31b that receives light emitted from the optical system 31a, and an AF motor 31c. The AF motor 31c is a member for automatically focusing on the drawing portion of the workpiece W by driving a focusing lens of the optical system 31a. The autofocus method is not particularly limited, and examples thereof include a contrast method.

The image sensor 31b includes, for example, a complementary metal oxide semiconductor (CMOS) sensor or the like. The image sensor 31b images the workpiece W to be drawn and generates a captured image. For example, although not illustrated, the light reception amount signal of the light receiving element of the image sensor 31b is output to a field programmable gate array (FPGA) and processed, and is also output to a digital signal processor (DSP) and processed.

The control section 32 includes an imaging setting section 32a. The imaging setting section 32a is a part that sets the imaging setting parameters and reflects the set imaging setting parameters at the time of imaging the workpiece W. The imaging setting parameters include, for example, a plurality of parameters such as timing of illumination by the illumination section 30, brightness (light emission amount), exposure time by the imaging section 31, and focus (focal position) of the imaging section 31. Although not illustrated, the GUI related to the setting of the imaging setting parameters is provided with an area in which brightness of illumination, exposure time, focus, and the like can be individually set. When the user inputs each parameter on the GUI, the imaging setting section 32a accepts a setting operation by the user, outputs each parameter to, for example, the storage section 33, and causes the storage section 33 to store the parameter. Each parameter can be read from the storage section 33 as necessary.

When acquiring the captured image data of the workpiece W, the imaging setting section 32a outputs the imaging setting parameters to the illumination section 30 and the imaging section 31. The illumination section 30 and the imaging section 31 operate according to the imaging setting parameters. Upon receiving the imaging setting parameter, the illumination section 30 sets the received imaging setting parameter in the imaging section 31 so as to reflect the received imaging setting parameter at the time of imaging. Furthermore, when receiving the imaging setting parameter, the imaging section 31 also sets the received imaging setting parameter in the imaging section 31 so as to reflect the received imaging setting parameter at the time of imaging. Upon receiving the imaging trigger, the illumination section 30 and the imaging section 31 illuminate the workpiece W in accordance with the imaging setting parameters and acquire captured image data of the workpiece W by imaging.

The control section 32 may be a part that executes the rule-based image inspection, a part that executes the image inspection using the pre-learned model, or a part that executes both the rule-based image inspection and the image inspection using the pre-learned model as the inspection tool. For example, the control section 32 causes the imaging section 31 to image the workpiece W, acquires captured image data of the workpiece W, and executes an inspection based on a set inspection tool on the acquired captured image of the workpiece W. When executing the inspection, the control section 32 cuts out a range to be inspected from the captured image. The control section 32 extracts a feature amount of the cut inspection range, and determines the extracted characteristic amount by a determination device. In a case where characters are included in the cut out inspection range, the inspection machine 3 can perform character recognition processing, so-called OCR, by using the dictionary when performing character recognition. Furthermore, in a case where a bar code or a two-dimensional code is drawn on the workpiece W, the bar code or the two-dimensional code can be read by the inspection machine 3.

A quality determination section 32b provided in the control section 32 of the inspection machine 3 creates an inspection result by the inspection tool and compares the inspection result with the inspection condition at this time. The inspection condition is acquired from a drawing data generation section 40b of the controller 4. The quality determination section 32b compares, for example, the result of the character recognition processing by the control section 32 with the correct character string acquired from the drawing data generation section 40b, and determines that it is good in a case where they match, and determines that it is defective in a case where they do not match. In the case of a barcode or a two-dimensional code, the reading result of the control section 32 is compared with the code information acquired from the drawing data generation section 40b, and in a case where the reading result matches the code information, it is determined as good, and in a case where the reading result does not match the code information, it is determined as defective.

For example, in a case where there is one set inspection tool, the inspection result related to the set inspection tool is output as it is, but in a case where a plurality of set inspection tools are combined, the inspection result is further generated on the basis of the inspection result of each inspection tool and output from the quality determination section 32b.

### (Integral Metal Fitting)

As illustrated in FIG. 1, the inkjet print apparatus 1 includes an integral metal fitting 90 for fixing the inspection machine 3 to a main housing 25 that accommodates the print head 22. The integral metal fitting 90 has a portion to which the main housing 25 is attached and a portion to which the inspection machine 3 is attached. The integral metal fitting 90 has a predetermined dimension in the conveying direction of the workpiece W, and when the inspection machine 3 is fixed to the main housing 25 by the integral metal fitting 90, the inspection machine 3 and the print head 22 can be in a positional relationship of being spaced apart from each other in the conveying direction of the workpiece W, that is, a fixed positional relationship. By fixing the inspection machine 3 to the main housing 25 with the integral metal fitting 90, a relative fixing positional relationship with the print head 22 is defined.

The shape and structure of the integral metal fitting 90 can be arbitrarily set. Furthermore, the length of the integral metal fitting 90 can also be arbitrarily set. The integral metal fitting 90 may be capable of adjusting the length of the workpiece W in the conveying direction. Furthermore, the integral metal fitting 90 may be configured to be able to change a separation distance of the inspection machine 3 from the main housing 25.

The integral metal fitting 90 is detachably attached to the main housing 25 by, for example, a fastening member or the like, and is also detachably attached to the inspection machine 3 by, for example, a fastening member or the like. As a result, the inspection machine 3 can be attached to and detached from the main housing 25.

There may be a plurality of types of the integral metal fittings 90. The integral metal fitting 90 having different dimensions is prepared in advance, and the inspection machine 3 can be fixed to the main housing 25 using the integral metal fitting 90 having an appropriate length according to the user's environment.

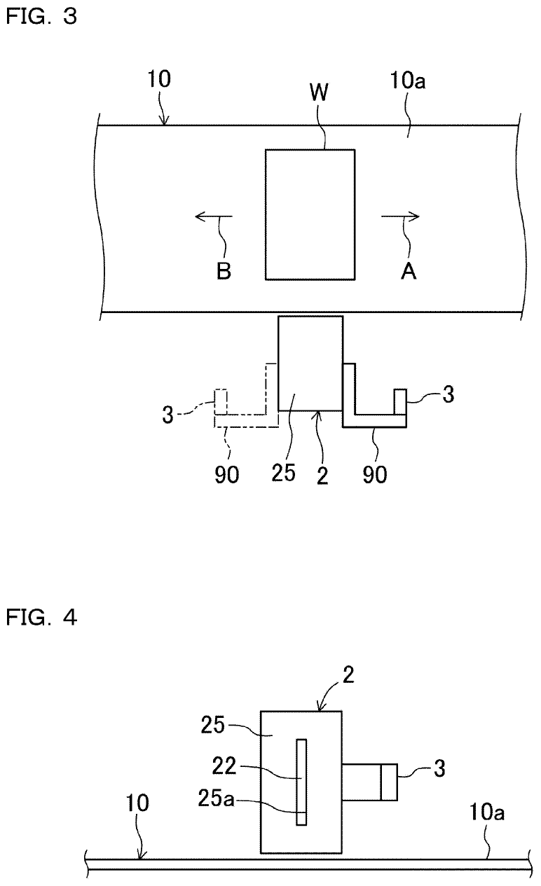

FIG. 3 is a plan view illustrating an installation example of the drawing machine 2 and the inspection machine 3. In a case where the workpiece W is conveyed in the direction of the arrow A, the inspection machine 3 can be installed on the downstream side of the drawing machine 2 in the conveyance direction of the workpiece W by providing the integral metal fitting 90 as indicated by the solid line. On the other hand, in a case where the workpiece W is conveyed in the direction of the arrow B opposite to the direction of the arrow A, the inspection machine 3 can be installed on the downstream side of the drawing machine 2 in the conveyance direction of the workpiece W by providing the integral metal fitting 90 as indicated by a virtual line. In addition, by simultaneously providing the integral metal fitting indicated by a solid line and the integral metal fitting 90 indicated by a virtual line, it is possible to cope with both the direction of arrow A and the direction of arrow B.

FIG. 4 illustrates an installation example of the drawing machine 2 and the inspection machine 3, and is a view (front view) as viewed from a side where ink is ejected. As illustrated in FIG. 4, the inspection machine 3 is fixed to the main housing 25 by the integral metal fitting 90 such that a center of the drawing area in the up-down direction and a center of the field of view of the imaging section 31 of the inspection machine 3 in the up-down direction have the same height.

### (Detection Sensor)

As illustrated in FIG. 1, the inkjet print apparatus 1 includes the detection sensor 9 that detects arrival of the workpiece W conveyed by the conveyor 10. The detection sensor 9 is installed on the upstream side of the drawing machine 2 in the conveying direction of the workpiece W. The detection sensor 9 is provided with, for example, an optical movement measurement sensor, a distance sensor, and the like (not illustrated), and these sensors can detect arrival of the conveyed workpiece W. When detecting the arrival of the workpiece W, the detection sensor 9 transmits a detection signal to the controller 4. The controller 4 determines that the workpiece W has arrived at a predetermined position on the basis of the detection signal output from the detection sensor 9, and causes the drawing machine 2 to start drawing after a predetermined drawing delay time has elapsed.

Furthermore, although details will be described later, in the present embodiment, the detection signal output from the detection sensor 9 is also used for generating an imaging trigger of the imaging section 31, and the imaging section 31 is caused to perform imaging after it is determined that the workpiece W has arrived at a predetermined position and a predetermined imaging delay time has elapsed.

### (Configuration of Controller 4)

As illustrated in FIG. 2, the controller 4 includes a control section 40, a storage section 41, and an operation display section 42. The control section 40 includes, for example, a microcomputer including a central processing section, various memories, and the like, and can execute software stored in advance. The control section 40 is provided with a drawing setting section 40a, the drawing data generation section 40b, an inspection setting section 40c, a display screen generation section 40d, and a mode switching section 40e. The drawing setting section 40a, the drawing data generation section 40b, the inspection setting section 40c, the display screen generation section 40d, and the mode switching section 40e of the control section 40 are parts configured by hardware and software, and are described separately for convenience as the drawing setting section 40a, the drawing data generation section 40b, the inspection setting section 40c, the display screen generation section 40d, and the mode switching section 40e, but may be integrated in hardware.

The operation display section 42 includes a controller-side display section 42a including, for example, a liquid crystal display and a controller-side operation section 42b including operation keys and the like. The controller-side operation section 42b is a part that receives various operations such as drawing contents and settings. Various screens generated by the display screen generation section 40d are displayed on the controller-side display section 42a, and the user can operate the controller-side operation section 42b while viewing the controller-side display section 42a. The operation state of the controller-side operation section 42b can be acquired by the control section 40.

The controller-side operation section 42b may be a touch panel. The touch panel is a member capable of detecting an operation by a user's finger. The type of the touch panel is not particularly limited, and examples thereof include a capacitance type and an infrared type. Operation information of the touch panel by the user is transmitted to the control section 40.

The drawing setting section 40a is a part that sets a drawing content to be drawn on the workpiece W to be drawn. The drawing data generation section 40b is a part that defines ejection of ink in the print head 22 and generates drawing data corresponding to the drawing content set by the drawing setting section 40a. The control section 40 outputs a control signal to the print head drive section 21 on the basis of the drawing data generated by the drawing data generation section 40b, and controls ejection of ink from the ejection port of the print head 22.

The inspection setting section 40c is a part that performs inspection setting by the inspection machine 3. The storage section 41 is a part that stores a relative fixed positional relationship between the inspection machine 3 and the print head 22. The inspection setting section 40c supports the inspection setting by the user on the basis of the drawing content set by the drawing setting section 40a and the relative fixed positional relationship stored in the storage section 41.

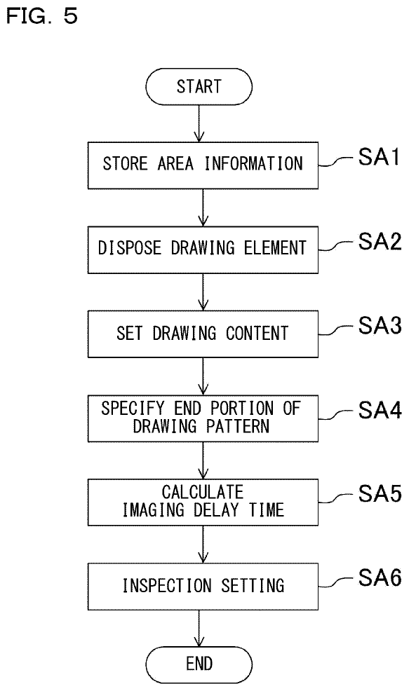

The details of the drawing setting and the inspection setting will be described below with reference to the flowchart of FIG. 5. In step SA1 after the start of this flowchart, area information indicating an area where the drawing pattern on the workpiece W can be captured is stored in the storage section 41. The area information is determined on the basis of an angle of view information defining an imaging field of view of the imaging section 31. The angle of view information is information for determining the size of the image area used in the image inspection. For example, in a case where a part of the image acquired by the image sensor 31b is enlarged and cut out by digital zoom, and the image inspection is performed on the cut-out area, the information for determining the cut-out area corresponds to the angle of view information. Furthermore, a distance to the drawing pattern can be acquired on the basis of the operation amount of the AF motor 31c, and the distance information may be included in the angle of view information.

The storage section 41 can store the area information determined on the basis of a relative positional relationship of the imaging section 31 with respect to the print head 22 and the angle of view information. In the present embodiment, since the integral metal fitting 90 for making the inspection machine 3 and the print head 22 in a fixed positional relationship spaced apart from each other in the conveying direction of the workpiece W is used, the relative positional relationship of the imaging section 31 with respect to the print head 22 can be accurately specified.

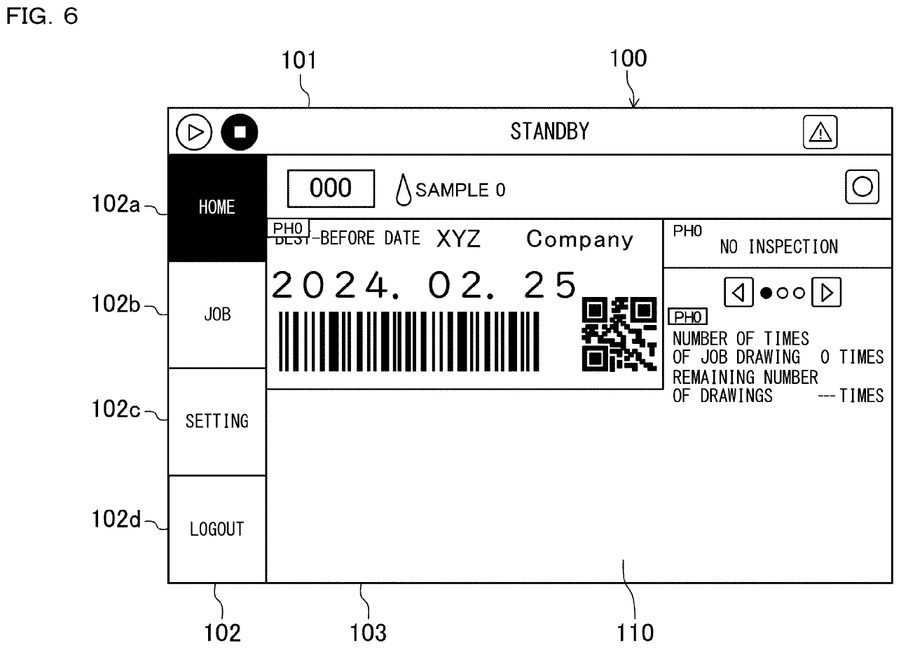

In step SA2, the display screen generation section 40d generates screen data for displaying a setting screen 100 as illustrated in FIG. 6, outputs the screen data to the controller 4, and causes the controller-side display section 42a to display the setting screen 100.

On the upper part of the setting screen 100, a status display area 101 for displaying the status of the inkjet print apparatus 1 is provided. A screen switching area 102 is provided on the left side of the setting screen 100. The screen switching area 102 is provided with a home button 102a for displaying a home screen, a job button 102b for displaying a job editing screen, a setting button 102c for displaying a setting screen for performing various settings, and a logout button 102d for ending drawing settings. The buttons 102a to 102d can be operated by the controller-side operation section 42b. Hereinafter, all operations on the screen can be operated by the controller-side operation section 42b.

FIG. 6 illustrates a state in which the home button 102a is pressed, and thus, the home screen 110 is displayed in an area 103 on the right side of the screen switching area 102 on the setting screen 100.

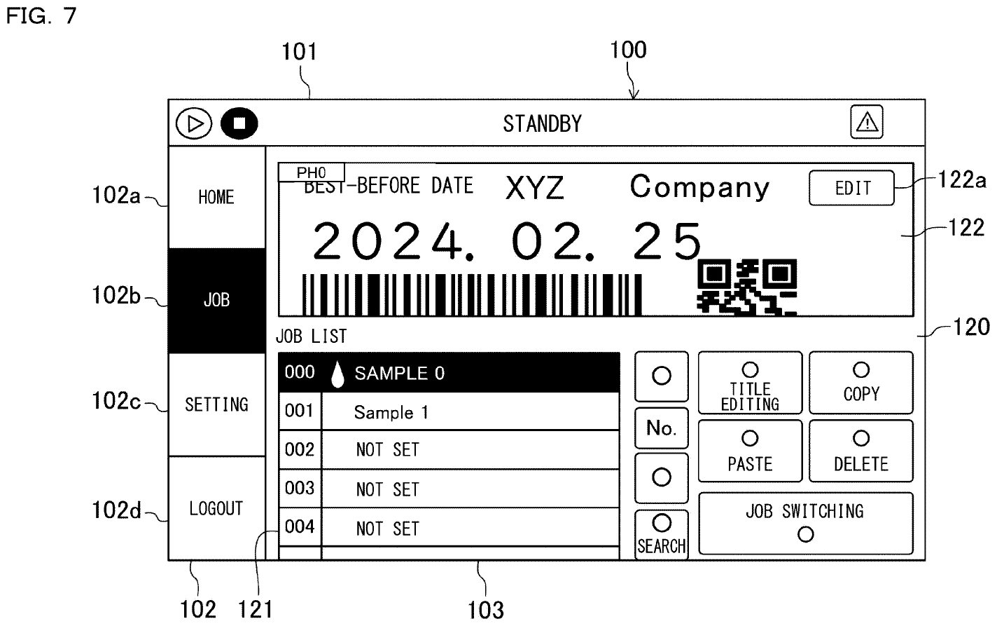

When the user operates the controller-side operation section 42b to press the job button 102b on the setting screen 100, as illustrated in FIG. 7, the display screen generation section 40d generates screen data for displaying the job editing screen 120 in the area 103 of the setting screen 100 and displays the screen data on the controller-side display section 42a. On the job editing screen 120, the drawing setting section 40a receives selection of a job to be edited from the user. That is, a job display area 121 in which a list of jobs is displayed is provided in a lower portion of the job editing screen 120. In the state illustrated in FIG. 7, the uppermost job “000 SAMPLE 0 ” in the job display area 121 is selected. A drawing content display area 122 is provided in an upper portion of the job editing screen 120. The drawing content display area 122 displays the drawing content of the job selected in the job display area 121. The drawing content display area 122 is provided with an edit button 122a.

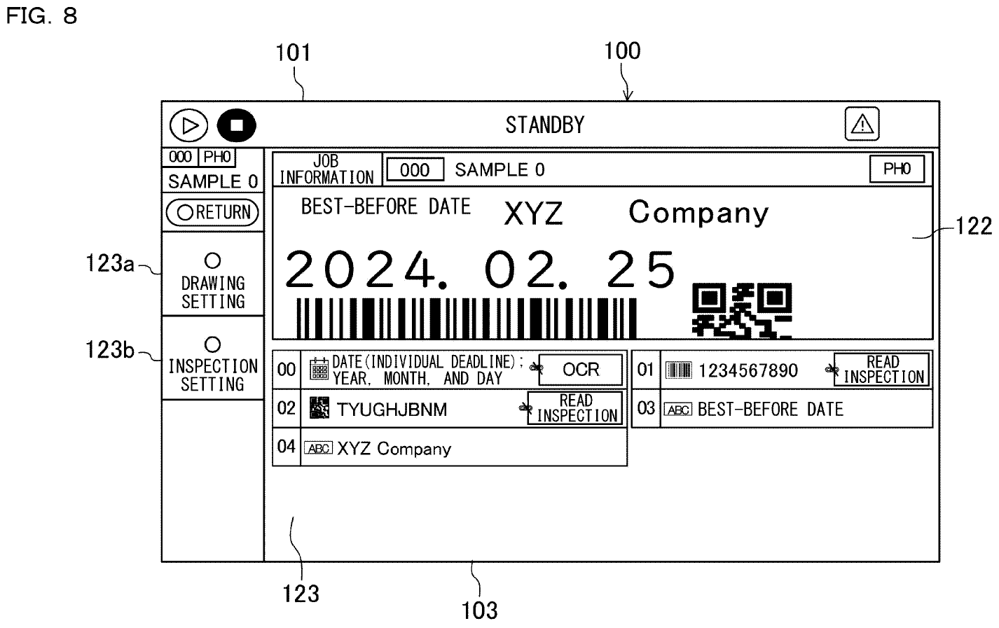

When the display screen generation section 40d detects that the edit button 122a is operated by the user, a drawing element display area 123 is displayed in the lower portion of the drawing content display area 122 as illustrated in FIG. 8. In the drawing element display area 123, a list of drawing elements is displayed. In the example illustrated in FIG. 8, since there are a date of “00”, a barcode of “01”, a two-dimensional code of “02”, a character string “best-before date” of “03”, and a character string “XYZ Company” of “04” as the drawing elements, five drawing elements are displayed in the drawing element display area 123.

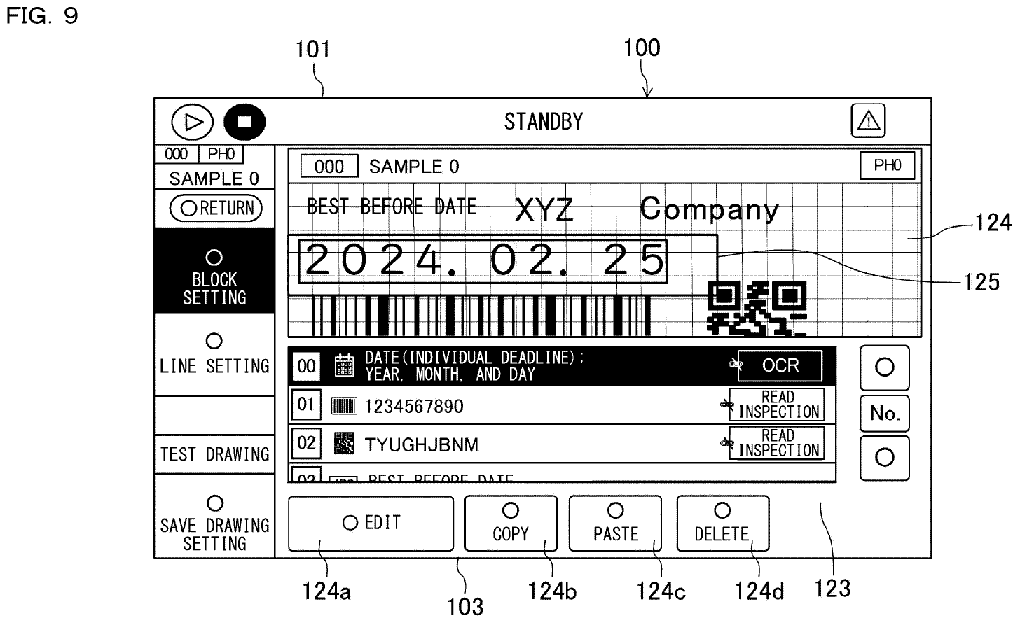

As illustrated in FIG. 8, a drawing setting button 123a and an inspection setting button 123b are provided on the left side of the drawing content display area 122. When the drawing setting button 123a is operated, drawing setting is started, and a drawing setting screen is displayed on the setting screen 100. Specifically, as illustrated in FIG. 9, an addition screen 124 on which blocks (also referred to as drawing blocks) can be disposed is displayed. The block indicates an area for disposing the element, and the element is displayed in the block. The addition screen 124 is a part that displays a setting surface corresponding to a drawing area on the workpiece W that is to be drawn with the ink ejected from the print head 22. That is, the controller-side display section 42a is a member for displaying the setting surface. Then, the drawing setting section 40a disposes an element corresponding to the drawing pattern on the setting surface displayed on the controller-side display section 42a on the basis of a user operation.

The drawing element display area 123 is provided below the addition screen 124, and an edit button 124a, a copy button 124b, a paste button 124c, and a delete button 124d for the added block are provided below the drawing element display area 123. The added blocks are indicated by frame lines 125 (see FIG. 9). The added block can be copied by the copy button 124b and pasted by the paste button 124c. Furthermore, the added block can also be deleted by the delete button 124d.

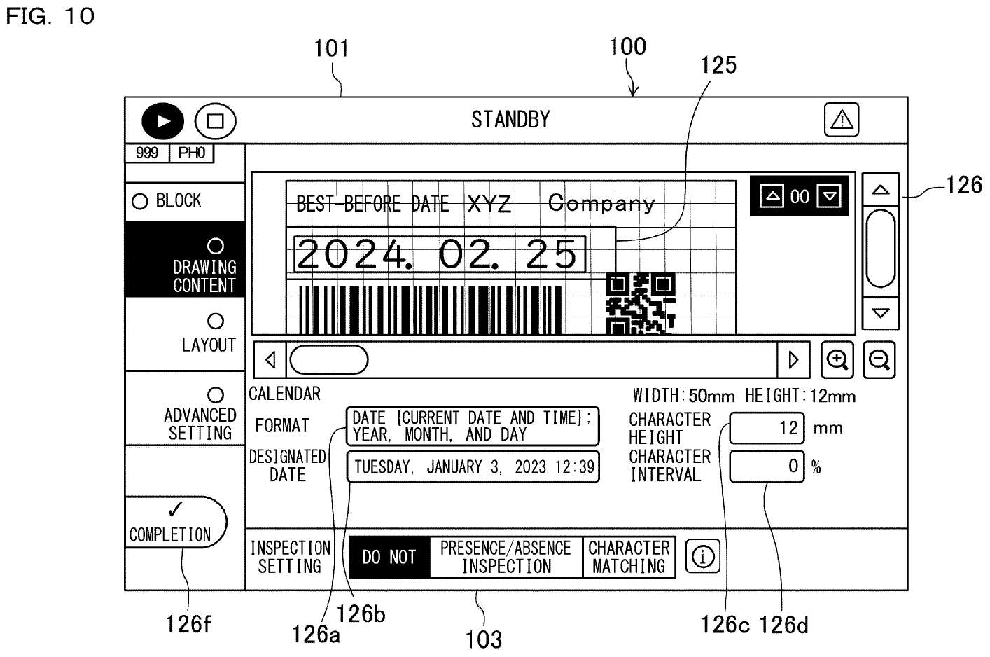

When the edit button 124a is operated in a state where the added block exists, as illustrated in FIG. 10, the display screen generation section 40d generates screen data for displaying the block editing screen 126 in the area 103 of the setting screen 100, and displays the screen data on the controller-side display section 42a. For example, in a case where the block is a calendar, the block editing screen 126 is provided with a format setting area 126a, a setting area 126b for a designated date, a setting area 126c for a character height (character size), a setting area 126d for a character interval, and the like.

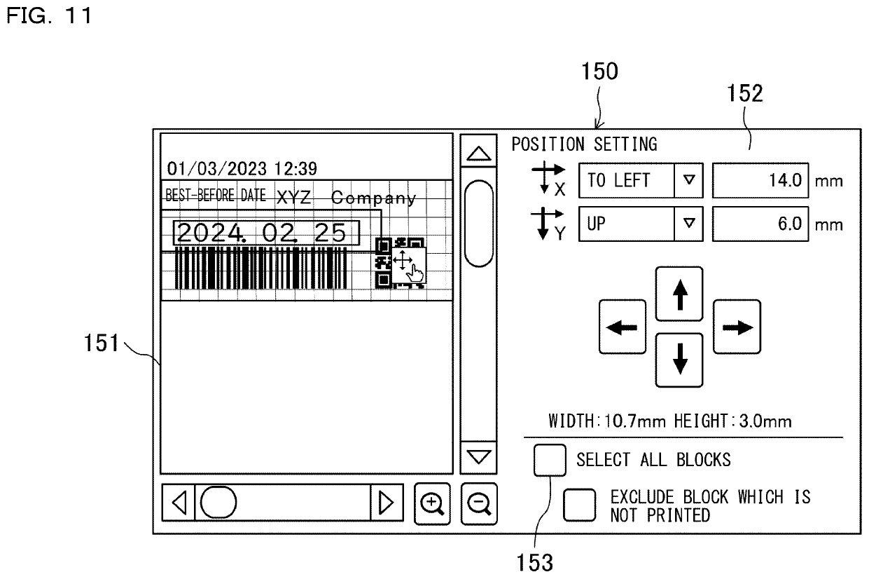

When the position of the block is adjusted, an adjustment screen 150 as illustrated in FIG. 11 is displayed on the controller-side display section 42a. The adjustment screen 150 is provided with a display area 151 in which drawing elements are displayed and a position adjustment area 152. The drawing element displayed in the display area 151 and the inspection tool are linked, and when the position of the drawing element is adjusted in the position adjustment area 152, the adjustment is reflected in the position adjustment of the area of interest of the inspection tool. In the position adjustment area 152, for example, an arrow in a direction in which position adjustment is desired can be operated, a movement amount can be input as a numerical value, and the like. Furthermore, in the position adjustment area 152, there is also provided a selection area 153 to be selected when the positions of all the blocks are collectively adjusted.

After the one or more blocks are disposed and the initial position is adjusted as described above, the process proceeds to step SA3 in FIG. 5. In step SA3, the user performs a setting operation of a drawing content. When the user operates a completion button 126f illustrated in FIG. 10, the drawing setting section 40a determines and temporarily saves the drawing content. That is, the drawing setting section 40a disposes the elements corresponding to the drawing pattern on the setting surface on the basis of the user operation, and then sets the drawing content including the disposed elements.

A plurality of elements corresponding to the drawing pattern can be disposed on the setting surface. For example, the plurality of elements can be disposed side by side in the conveyance direction by the conveyor 10, disposed side by side in a direction orthogonal to the conveyance direction by the conveyor 10, and the like.

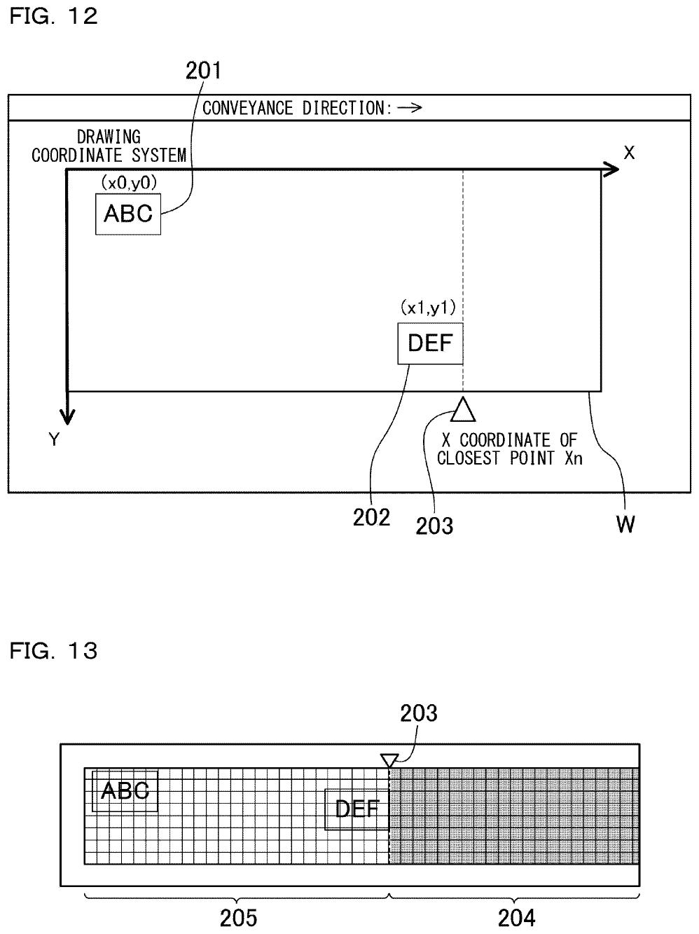

In step SA4, the drawing setting section 40a specifies the end portion of the drawing pattern in the conveyance direction by the conveyor 10 on the basis of the position of the element disposed on the setting surface. In the present embodiment, the end portion of the drawing pattern in the conveyance direction is also referred to as a “closest point” as illustrated in FIG. 12.

The end portion (closest point) of the drawing pattern can be specified by the conveying direction of the conveyor 10 and the drawing content. The conveyance direction by the conveyor 10 can be input by a user, and can be input as, for example, an arrow A direction or an arrow B direction illustrated in FIG. 3. The drawing setting section 40a acquires the conveyance direction by the conveyor 10 input by the user.

For example, a case where drawing contents as illustrated in FIG. 12 are set by the drawing setting section 40a will be described. In FIG. 12, the conveyance direction by the conveyor 10 is the right direction, the conveyance direction by the conveyor 10 is the X direction, and the direction orthogonal to the conveyance direction is the Y direction. The drawing pattern drawn on the workpiece W includes a first block 201 including a character string “ABC” disposed on the upstream side in the conveyance direction and a second block 202 including a character string “DEF” disposed on the downstream side. In this case, the drawing setting section 40a specifies, as the closest point 203, an end portion on the upstream side of the second block 202 disposed on the upstream side in the conveyance direction. As described above, in a case where a plurality of elements are included in a single drawing content, the drawing setting section 40a specifies, as an end portion of the drawing pattern, an end portion on the upstream side of an element located most upstream in the conveyance direction among the plurality of elements. The end portion on the upstream side of the element is a part where drawing is initiated by the print head 22.

FIG. 13 is a diagram illustrating an example of a display form by the controller-side display section 42a. In the display format illustrated in FIG. 13, the area 204 on the upstream side in the conveyance direction with respect to the closest point 203 specified by the drawing setting section 40a is colored in gray, while the area 205 on the downstream side in the conveyance direction with respect to the closest point 203 is not colored in gray. As a result, the area 204 on the upstream side of the closest point 203, that is, the area that is not the drawing target can be indicated in an easily understandable manner. This display format is an example, and in addition to the display format in which the color of the area 204 on the upstream side in the conveyance direction and the color of the area 205 on the downstream side in the conveyance direction are changed, the areas 204 and 205 can be distinguished from each other by changing the type of hatching to be applied to the areas 204 and 205. That is, the controller-side display section 42a is configured such that the area 204 on the upstream side in the conveyance direction with respect to the end portion of the drawing pattern and the area 205 on the downstream side in the conveyance direction with respect to the end portion of the drawing pattern have different display modes.

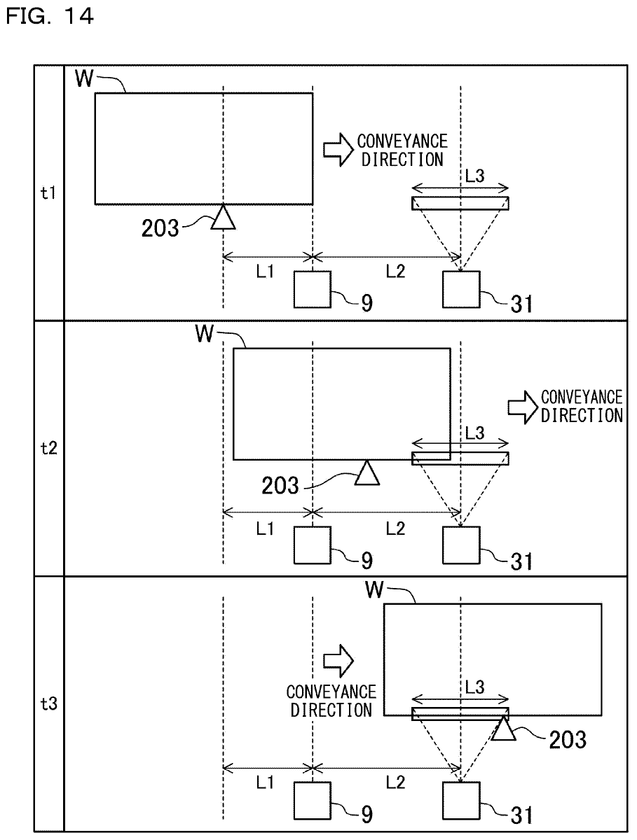

In step SA5, the control section 40 calculates an imaging delay time. The calculated imaging delay time can be stored in the storage section 41 or the like, for example. FIG. 14 is a schematic diagram of the workpiece W conveyed by the conveyor 10 as viewed from above.

The conveyance direction is the right direction, the imaging section 31 is installed on the downstream side in the conveyance direction, and the detection sensor 9 is installed on the upstream side in the conveyance direction with respect to the imaging section 31. The distance L1 is a distance from the upstream edge of the workpiece W in the conveyance direction to the closest point 203, and can be acquired through steps SA3 and SA4 in FIG. 5. A distance L2 is a known distance between the detection sensor 9 and the center of the imaging field of view of the imaging section 31. The distance L3 is a dimension of the imaging field of view of the imaging section 31 (dimension in a direction along the conveyance direction), and can be acquired on the basis of the angle of view information. The time advances in the order of time t1, time t2, and time t3.

Time t1 is a timing at which the detection sensor 9 detects the upstream edge of the workpiece W being conveyed by the conveyor 10. Time t2 is a timing at which the upstream edge of the workpiece W enters the imaging field of view of the imaging section 31, but the closest point 203 does not yet enter the imaging field of view of the imaging section 31 at time t2. At time t3, it is a timing at which the closest point 203 is on the upstream side of the imaging field of view of the imaging section 31, and by issuing the imaging trigger at time t3, the imaging section 31 can acquire the drawing content with the closest point 203 as the field angle end. In order to cause the imaging section 31 to execute imaging so that the closest point 203 enters the imaging field of view of the imaging section 31, the control section 40 acquires the calculation result of L1+L2+L3/2 and the detection timing of the workpiece W by the detection sensor 9, and calculates the imaging delay so as to issue the imaging trigger at the timing when the closest point 203 enters the imaging field of view of the imaging section 31.

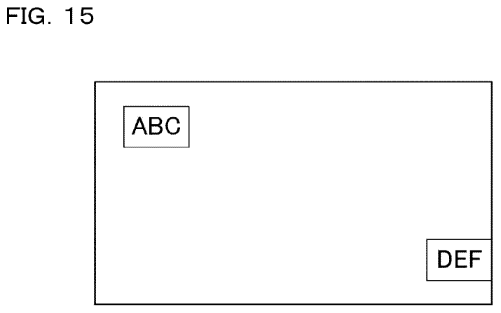

That is, the control section 40 determines the issuance timing of the imaging trigger on the basis of the area information stored in the storage section 41, the position of the element disposed on the setting surface by the drawing setting section 40a, and the detection timing of the detection sensor 9, and causes the imaging section 31 to execute imaging. FIG. 15 illustrates an example of an image captured by the imaging section 31 at time t3. In this manner, the control section 40 determines the issuance timing of the imaging trigger such that all of the plurality of elements fall within the imaging field of view of the imaging section 31.

For example, the positional relationship between the closest point 203 and the imaging section 31 does not change even if the drawing content is different for each workpiece W such as the date and the lot number, and thus, all the captured images are images including the closest point 203 at the field angle end.

The control section 40 determines the issuance timing of the imaging trigger such that the closest point 203, which is the end portion of the drawing pattern specified by the drawing setting section 40a, is located closer to the center of the imaging field of view than an end portion of the imaging field of view of the imaging section 31. That is, since an error may occur in the detection timing of the workpiece W, the issuance timing of the imaging trigger is delayed so as to be positioned slightly downstream from the angle-of-view end so that the closest point 203 does not overlap the angle-of-view end. The issuance timing of the imaging trigger is set so as to be able to cope with the error of the detection timing.

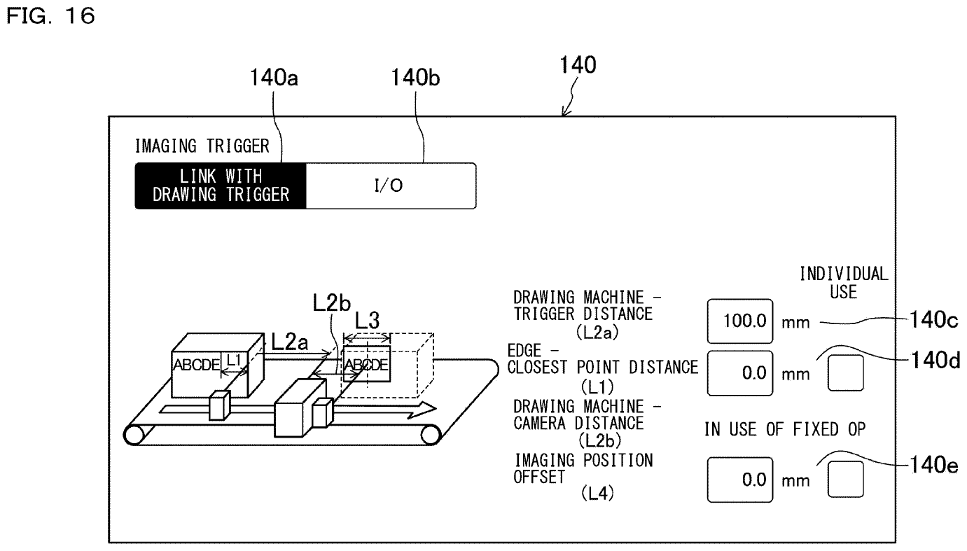

FIG. 16 illustrates an input screen 140 for receiving an input of parameters related to the distances L1 and L2 by the user, and the input screen 140 is generated by the display screen generation section 40d and displayed on the controller-side display section 42a. On the input screen 140, it is possible to select whether or not to link the imaging trigger with the drawing trigger. That is, the input screen 140 is provided with a link button 140a that is operated when the imaging trigger is caused to be linked with the drawing trigger, and a non-link button 140b. In a case where the link button 140a is operated, the imaging trigger is caused to be linked with the drawing trigger, and in a case where the non-link button 140b is operated, the imaging section 31 executes imaging with the externally input imaging trigger without causing the imaging trigger to be linked with the drawing trigger.

In a case where the link button 140a is operated, an area 140c for inputting the distance L2a between the print head 22 and the detection sensor, the distance L2a constituting the distance L2, an area 140d for inputting the distance L1, and an area 140e for inputting the imaging position offset (L4) are displayed on the input screen 140. The user inputs distances to the areas 140c, 140d, and 140e, respectively. On the basis of the input result, the control section 40 can obtain a calculation result of L1+L2+L3/2. Note that the screen for inputting each distance is not limited to the input screen 140, and may be any screen.

Identification of the closest point 203 enables alignment between the drawing area and the setting surface corresponding to the drawing area, and a drawing trigger is issued so that the closest point 203 of the element disposed on the setting surface corresponding to the drawing area is drawn at a position separated from the edge of the workpiece W by the distance L1 input to the area 140d. In other words, the distance L1 is a distance from the edge of the workpiece W in the drawing area to the position where the closest point 203 is drawn, of the element disposed on the setting surface corresponding to the drawing area.

The distance L2 includes a distance L2a and a distance L2b between the print head 22 and the imaging section 31. In other words, since the detection sensor 9, the print head 22, and the imaging section 31 are arranged in this order from the upstream to the downstream in the conveying direction of the workpiece W, the first distance in the arrangement direction of the detection sensor 9 and the imaging section 31 is a distance obtained by adding the second distance in the arrangement direction of the detection sensor 9 and the print head 22 and the third distance in the arrangement direction of the print head 22 and the imaging section 31. Since the distance L2b in the conveyance direction between the print head 22 and the imaging section 31 of which the relative positional relationship is defined by the integral metal fitting 90 is stored in the storage section 41, the distance L2 can be calculated by adding the distance L2a input to the area 140c. In a case where the setting not to use the integral metal fitting 90 is made, there is a possibility that the relative positional relationship between the print head 22 and the imaging section 31 is different from the relative positional relationship stored in the storage section 41, and thus, an area for the user to input the distance L2b is displayed on the input screen 140 similarly to other parameters.

The distance L3 is determined on the basis of the angle of view information of the imaging section 31 and the fixed positional relationship between the print head 22 and the imaging section 31, and is included in the area information stored in the storage section 41. Specifically, the distance between both end portions in the arrangement direction of the print head 22 and the imaging section 31 in the area where the drawing pattern on the workpiece W can be imaged is determined as the distance L3. The determined value of the distance L3 is stored in the storage section 41.

The position offset L4 is a parameter for the user to adjust the distance between the closest point 203 and the end portion of the imaging field of view of the imaging section 31. For example, in a case where the area of the entire drawing pattern with respect to the imaging field of view is small, a captured image in which the drawing pattern is disposed in the central portion of the imaging field of view can be acquired by offsetting the closest point 203 and the end portion of the imaging field of view of the imaging section 31.

The distance L1 and the distance L2a are parameters also referred to when the delay time of the drawing trigger is calculated. That is, the control section 40 issues the drawing trigger at the timing when the workpiece W moves from the upstream to the downstream in the conveyance direction by the distance obtained by adding the distance L1 and the distance L2a after the detection sensor 9 detects the edge of the workpiece W. In other words, some of the parameters constituting the distances L1, L2, L3, and L4 necessary for calculating the imaging delay time of the imaging trigger are common to the distances L1 and L2a necessary for calculating the drawing delay time of the drawing trigger. That is, since the imaging trigger is linked with the drawing trigger, the positional shift of the captured image with respect to the drawing pattern formed on the workpiece W hardly occurs, and the user input of the setting is also facilitated. For example, even in a case where the distance L1 and the distance L2a input by the user to the areas 140c and 140d are wrong, the parameters to be referred to at the time of calculating the print delay time and the imaging delay time are common, so that the drawing timing and the imaging timing are not relatively shifted.

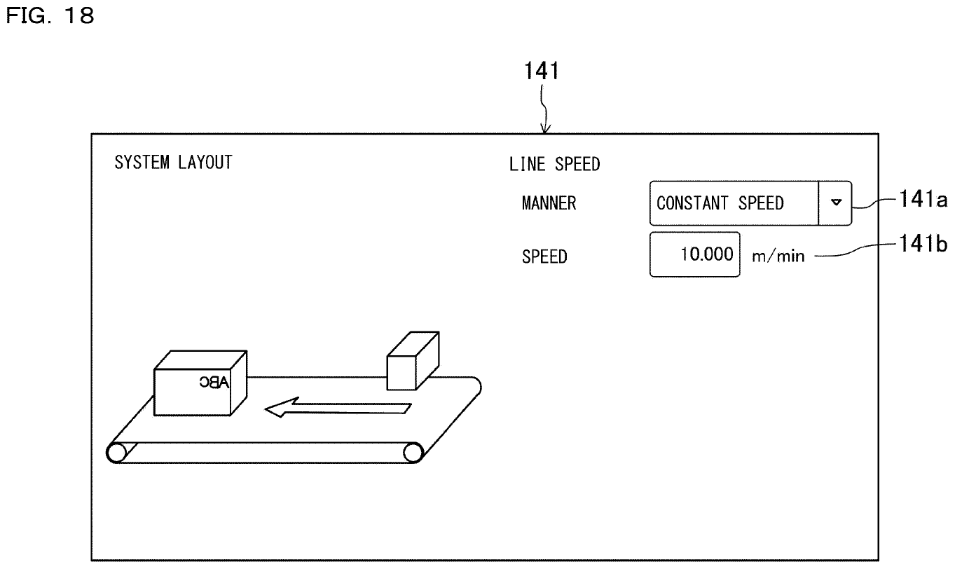

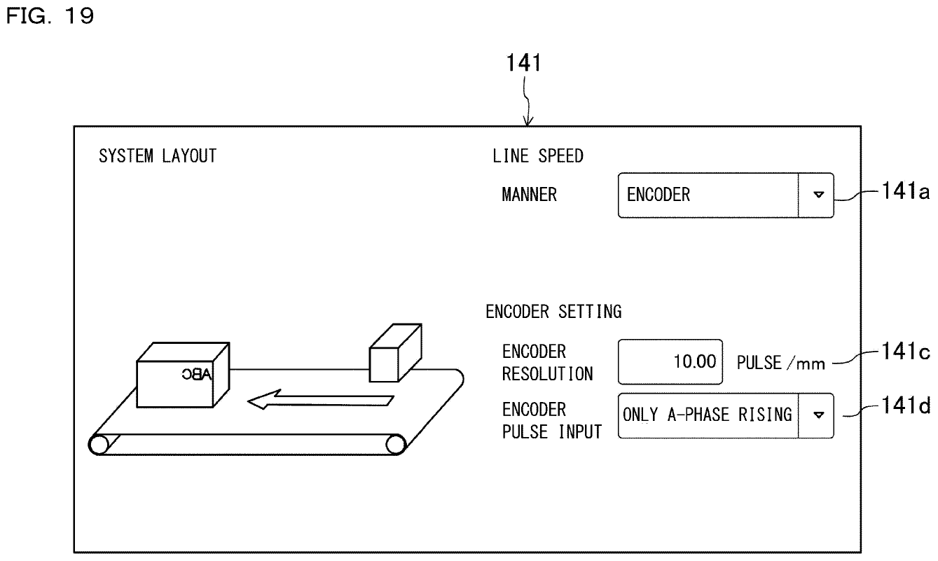

When the distances L1, L2, L3, and L4 are determined, the time can be calculated by acquiring speed information indicating that the workpiece W moves by being conveyed. The user can select a case where the speed information is acquired on the assumption that the workpiece W moves at a constant speed or a case where the speed information is acquired using the encoder 7. FIG. 18 illustrates an input screen 141 in a case where the workpiece W moves at a constant speed. Furthermore, FIG. 19 illustrates an input screen 141 in a case where the encoder 7 is used. The input screen 141 is provided with a speed information selection area 141a and a speed input area 141b. In the speed information selection area 141a, one of “constant speed” and “encoder” can be selected and input. In a case where “constant speed” is selected, the conveyance speed can be input to the speed input area 141b. The control section 40 calculates the time using the conveyance speed input to the speed input area 141b and the distances L1, L2, L3, and L4. On the other hand, in a case where the “encoder” is selected, a resolution input area 141c for inputting the encoder resolution and a pulse input area 141d for inputting the encoder pulse are displayed on the input screen 141 illustrated in FIG. 19. The control section 40 calculates the time using the distances L1, L2, and L3, the signal output from the encoder, the resolution input to the resolution input area 141c, and the pulse input to the pulse input area 141d.

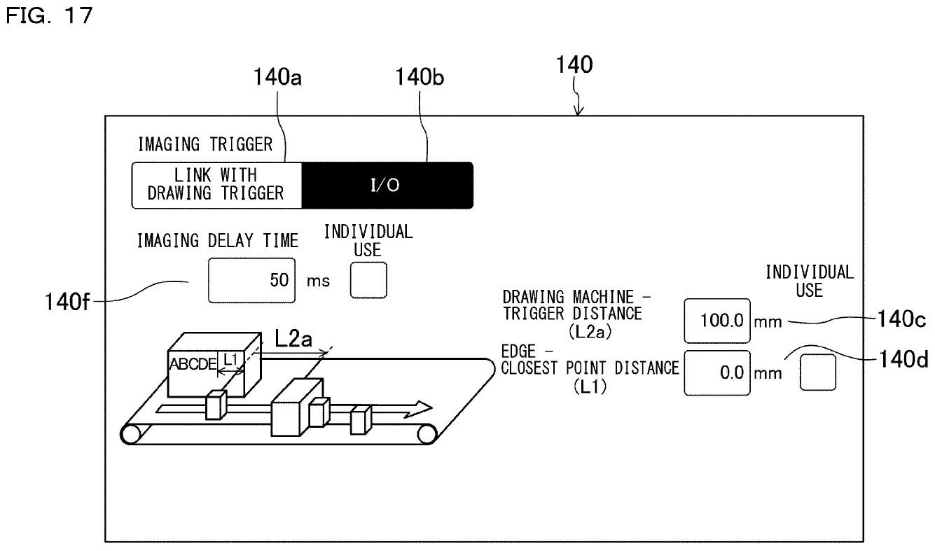

FIG. 17 illustrates the input screen 140 in a case where the non-link button 140b is operated. In a case where the non-link button 140b is operated, the area 140c for inputting the distance L2a, the area 140d for inputting the distance L1, and an area 140f for inputting the imaging delay time are displayed. In the area 140f, the delay time from the external input can be input as the imaging delay time. The imaging trigger is issued in a case where it is determined that the time input to the area 140f has elapsed after receiving the input from the detection sensor 9. In other words, the distance L2a and the distance L1 are used to determine the issuance timing of the drawing trigger, but are not used to calculate the issuance timing of the imaging trigger. That is, the imaging trigger and the drawing trigger are not linked with each other.

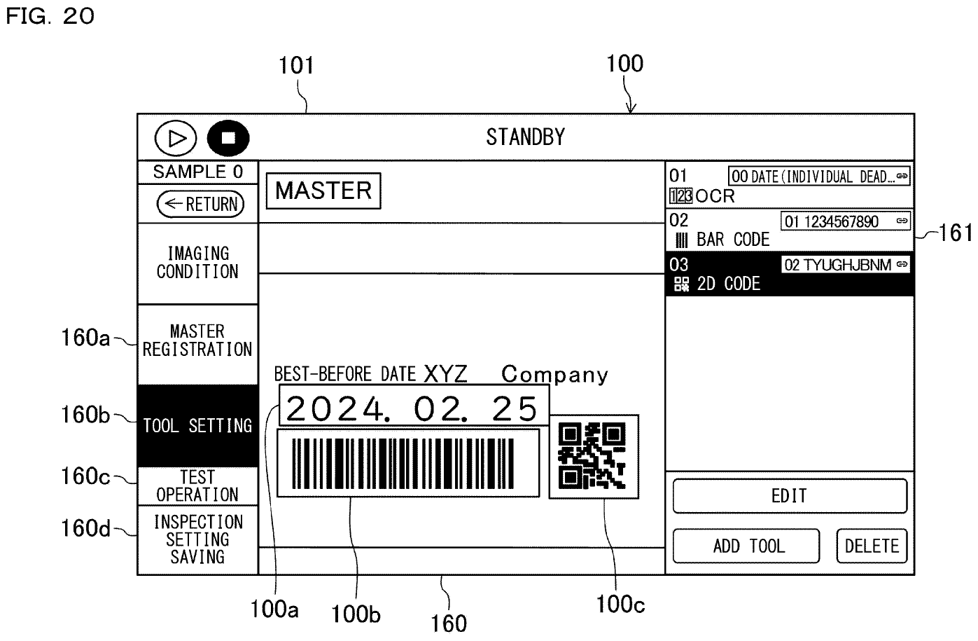

In step SA6 illustrated in FIG. 5, the inspection setting is started. For example, when the inspection setting button 123b illustrated in FIG. 8 is operated by the user, inspection setting is started, and an inspection setting screen is displayed on the setting screen 100 as illustrated in FIG. 20. The setting screen 100 illustrated in FIG. 20 is provided with a master image display area 160 and an inspection tool display area 161 in which a list of inspection tools is displayed. The master image of the workpiece W acquired by the imaging section 31 of the inspection machine 3 is displayed in the master image display area 160.

On the left side of the setting screen 100, a master registration button 160a, a tool setting button 160b, a test operation button 160c, and an inspection setting saving button 160d are provided. When the master registration button 160a is operated, the imaging section 31 images the workpiece W to acquire a master image, and the master image is displayed in the master image display area 160. When acquiring the master image, the imaging section 31 can generate the master image by imaging the drawing pattern formed on the workpiece W by the ink ejected from the print head 22.

The master image displayed in the master image display area 160 can be configured to select a master image from images acquired in the past on the basis of a user operation, or can be configured to be able to be selected by the user as to whether to select a master image from images acquired in the past or to acquire a master image by imaging the workpiece W by the imaging section 31. In a case where a master image is selected from images acquired in the past, after step SA5 in FIG. 5, the imaging section 31 can be controlled to capture an image of a drawing pattern formed on an object to be drawn by ink ejected from the ejection section when test printing is performed, and the acquired image can be displayed as a master image in the master image display area 160.

When the tool setting button 160b is operated, information on the inspection tool is displayed in the inspection tool display area 161. In this example, an area of interest 100a of the character string inspection tool, an area of interest 100b of the barcode inspection tool, and an area of interest 100c of the two-dimensional code inspection tool are displayed in the master image display area 160. The test operation can be tested by operating the test operation button 160c.

By performing the inspection setting, the block and the inspection tool are linked. Thereafter, when the user operates the inspection setting saving button 160d, the block and the inspection tool are saved in the storage section 41 or the like in a state where the block and the inspection tool are linked.

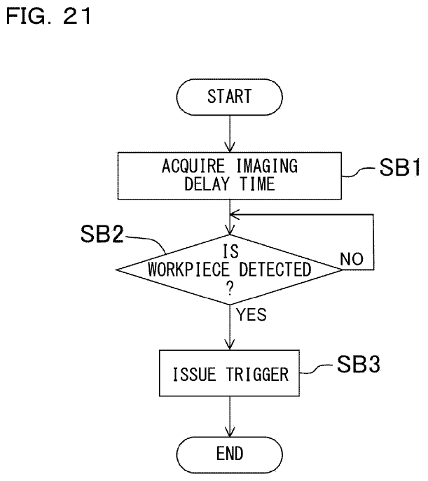

Next, the operation of the inkjet print apparatus 1 will be described with reference to a flowchart illustrated in FIG. 21. In step SB1, the control section 40 acquires the imaging delay time stored in the storage section 41 or the like. During operation, since the plurality of workpieces W are sequentially conveyed by the conveyor 10, the detection sensor 9 detects arrival of the workpiece W at a certain timing (step SB2).

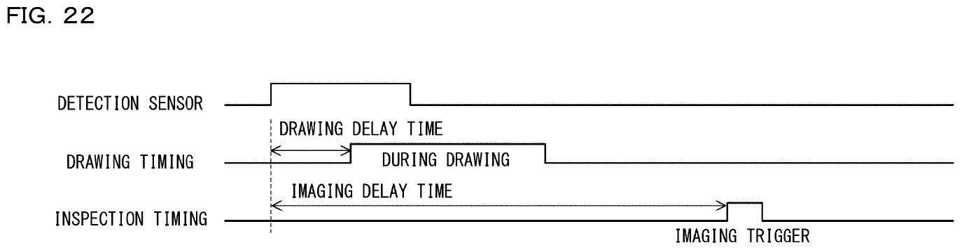

In step SB3, the control section 40 issues a trigger. FIG. 22 is a timing chart of the detection sensor 9, the drawing machine 2, and the inspection machine 3. When the detection sensor 9 detects the arrival of the workpiece W, the detection sensor 9 outputs a detection signal. Upon receiving the signal from the detection sensor 9, the control section 40 adds a predetermined drawing delay time and outputs a drawing start trigger to the drawing data generation section 40b. The drawing data generation section 40b that has received the drawing start trigger generates drawing data and outputs the drawing data to the drawing machine 2. The drawing machine 2 having received the drawing data executes drawing. As described above, the print head 22 ejects the ink to the workpiece W at the timing based on the detection timing of the detection sensor 9.

The control section 40 outputs an imaging trigger to the imaging section 31 so that after the drawing machine 2 executes drawing, the inspection machine 3 executes inspection of the drawing pattern. Specifically, when a signal from the detection sensor 9 is received, the imaging delay time acquired in step SB1 is added, and an imaging trigger is output to the imaging section 31. As described above, the control section 40 can determine the issuance timing of the imaging trigger on the basis of the timing at which the print head 22 ejects ink to the workpiece W. As a result, as illustrated at time t3 in FIG. 14, the captured image in which the closest point 203 is included in the field angle end can be acquired as the inspection image, so that the accurate inspection can be performed.

In the present embodiment, as the mode for imaging the drawing pattern, there are a first mode in which the imaging section 31 images the drawing pattern at a timing based on the area information stored in the storage section 41, the position of the element disposed on the setting surface by the drawing setting section 40a, and the detection timing of the detection sensor 9, and a second mode in which the imaging section 31 images the drawing pattern at a timing based on the delay time or the delay distance with respect to the detection timing of the detection sensor 9 set by the user and the detection timing of the detection sensor 9. Switching between the first mode and the second mode is executed by the mode switching section 40e (illustrated in FIG. 2). For example, when the user selects the first mode, the mode switching section 40e causes the imaging section 31 to execute imaging in the first mode, and when the user selects the second mode, the mode switching section 40e causes the imaging section 31 to execute imaging in the second mode.

The above-described embodiments are merely examples in all respects, and should not be construed in a limiting manner. Moreover, all modifications and changes falling within the equivalent scope of the claims are within the scope of the present invention.

As described above, the present disclosure can be used, for example, in a case where various types of information are drawn on a packaging material such as cardboard.

What is claimed is:

1. An inkjet print apparatus comprising:
an ink accommodation section configured to accommodate ink;
an ejection section configured to eject ink supplied from the ink accommodation section toward an object to be drawn conveyed by a conveyance device;
an imaging section configured to capture an image of a drawing pattern formed on the object to be drawn with the ink ejected from the ejection section and generate a captured image;
an image inspection section configured to perform image inspection of the drawing pattern using the captured image generated by the imaging section;
a storage section configured to store area information indicating an area in which an image of the drawing pattern on the object to be drawn can be captured, the area information being determined on a basis of an angle of view information defining an imaging field of view of the imaging section;
a display section configured to display a setting surface corresponding to the drawing area on the object to be drawn that is to be drawn with the ink ejected from the ejection section;
a setting section configured to, on a basis of a user operation, dispose an element according to the drawing pattern on the setting surface displayed on the display section and set a drawing content; a detection sensor configured to detect arrival of the object to be drawn conveyed by the conveyance device; and
a control section configured to determine an issuance timing of an imaging trigger on a basis of the area information stored in the storage section, a position of the element disposed on the setting surface by the setting section, and a detection timing of the detection sensor.

2. The inkjet print apparatus according to claim 1, wherein
the control section further determines the issuance timing of the imaging trigger on a basis of a first relative positional relationship in an arrangement direction of the detection sensor and the imaging section.

3. The inkjet print apparatus according to claim 1, wherein
the control section determines an issuance timing of a drawing trigger on a basis of a position of the element disposed on the setting surface by the setting section, a second relative positional relationship in an arrangement direction of the detection sensor and the ejection section, and a detection timing of the detection sensor, and
determines the issuance timing of the imaging trigger on a basis of the second relative positional relationship in the arrangement direction of the detection sensor and the ejection section, and a third relative positional relationship in an arrangement direction of the ejection section and the imaging section.

4. The inkjet print apparatus according to claim 3, further comprising
an input section configured to input the second relative positional relationship,
wherein the storage section stores the third relative positional relationship.

5. The inkjet print apparatus according to claim 1, wherein
the storage section stores the area information determined on a basis of a relative positional relationship of the imaging section with respect to the ejection section and the angle of view information.

6. The inkjet print apparatus according to claim 1, wherein
the ejection section ejects ink onto the object to be drawn at a timing based on the detection timing of the detection sensor, and
the control section determines the issuance timing of the imaging trigger on a basis of the area information stored in the storage section, the position of the element disposed on the setting surface by the setting section, and the timing at which the ejection section ejects ink onto the object to be drawn.

7. The inkjet print apparatus according to claim 1, wherein
the setting section specifies an end portion of the drawing pattern in a conveyance direction by the conveyance device on a basis of the position of the element disposed on the setting surface, and
the control section determines the issuance timing of the imaging trigger on a basis of a positional relationship between an end portion of an area indicated by the area information and the end portion of the drawing pattern specified by the setting section and the detection timing of the detection sensor.

8. The inkjet print apparatus according to claim 1, further comprising
a mode switching section configured to enable switching between:
a first mode in which the imaging section captures an image of the drawing pattern at a timing based on the area information stored in the storage section, the position of the element disposed on the setting surface by the setting section, and the detection timing of the detection sensor; and
a second mode in which the imaging section captures an image of the drawing pattern at a timing based on a delay time or a delay distance with respect to a detection timing of the detection sensor set by a user, and the detection timing of the detection sensor.

9. The inkjet print apparatus according to claim 1, wherein
the imaging section captures the image of the drawing pattern formed on the object to be drawn with the ink ejected from the ejection section to generate a master image.

10. The inkjet print apparatus according to claim 7, wherein
the setting section disposes, on a basis of a user operation, a plurality of the elements according to a drawing pattern on the setting surface displayed on the display section, and
the control section determines the issuance timing of the imaging trigger so that all of the plurality of elements are within the imaging field of view of the imaging section.

11. The inkjet print apparatus according to claim 7, wherein
the setting section disposes, on a basis of a user operation, a plurality of the elements according to a drawing pattern on the setting surface displayed on the display section, and specifies, as the end portion of the drawing pattern, an end portion of the element located most upstream in a conveyance direction by the conveyance device among the plurality of elements.

12. The inkjet print apparatus according to claim 7, wherein
the display section displays an area on an upstream side in a conveyance direction by the conveyance device with respect to an end portion of the drawing pattern specified by the setting section in different modes than an area on a downstream side in the conveyance direction by the conveyance device with respect to the end portion of the drawing pattern specified by the setting section.

13. The inkjet print apparatus according to claim 7, wherein
the control section determines the issuance timing of the imaging trigger such that the end portion of the drawing pattern specified by the setting section is located closer to a center of an imaging field of view than an end portion of the imaging field of view of the imaging section.
